(19) United States
(12) Patent Application Publication
(10) Pub. No.: US 2016/0205066 A1
(43) Pub. Date: Jul. 14, 2016

(54) UNIQUE DEVICE ADDRESS ASSIGNMENT TECHNIQUE FOR BIDIRECTIONAL DAISY CHAIN SYSTEM

(71) Applicant: Texas Instruments Incorporated, Dallas, TX (US)

(72) Inventors: Hussain K. Attarwala, Tucson, AZ (US); Ankit Khanna, Tucson, AZ (US); Dimitar T. Trifonov, Vail, AZ (US); Vasco D. Polyzoev, Santa Clara, CA (US); Biraja P. Dash, Tucson, AZ (US)

(73) Assignee: Texas Instruments Incorporated, Dallas, TX (US)

(21) Appl. No.: 14/984,321

(22) Filed: Dec. 30, 2015

Related U.S. Application Data
(60) Provisional application No. 62/101,788, filed on Jan. 9, 2015.

(51) Int. Cl. H04L 29/12; H04L 12/40; H04L 12/24

(52) U.S. Cl. CPC H04L 61/2076; H04L 41/0853; H04L 41/0813; H04L 12/40

(57) ABSTRACT

Devices, systems and methods are disclosed for assigning unique addresses to slave devices in a system comprising a host controller and multiple slave devices connected in a daisy chain configuration. The host controller initiates the address programming protocol, resulting in address assignment commands propagating along the daisy chain to each of the slave devices. Upon receiving an address assignment, each slave device issues an updated address assignment for the neighboring downstream slave device in the daisy chain. In this manner, slave devices are uniquely addressed using a single command, such that slave devices do not require factory-programmed device addresses. Also disclosed are communication protocols that allow the host controller to communicate with each of the daisy-chained slave devices or with certain subsets of the slave devices. Via the protocol, the host controller can communicate with any slave device in the daisy chain, while utilizing only the daisy chain connections that link the individual slave devices.

### CROSS-REFERENCE TO RELATED APPLICATIONS

The present application claims the benefit of the filing date of Provisional Application No. 62/101,788, filed Jan. 9, 2015.

### TECHNICAL FIELD

The recited claims are directed, in general, to communication bus protocols and, more specifically, to an address programming and communication protocol for a daisy chain system of devices connected by a single-wire communication bus.

### BACKGROUND

Individual devices may be connected to each other in a daisy chain configuration such that each individual device is connected to exactly two neighboring devices in the daisy chain, except for the first and last devices, which are connected to only one neighboring device. In certain daisy chain configurations, one of the terminal devices in the chain is a host controller device and the remaining devices in the chain are slave devices. In such a configuration, the host controller dispatches commands that are used to control and/or configure certain aspects of the operation of the slave devices. A daisy chain configuration of devices may be used for a variety of applications, including distributed sensor applications, such as distributed temperature sensing. Designing appropriate communication and addressing protocol for daisy chain configurations may present significant challenges.

This disclosure describes a protocol by which slave devices in a daisy chain configuration can be uniquely addressed by a host controller using a single wire connection between each of the devices in the daisy chain. In some examples, an address programming protocol may initiate a sequence of events that allow the slave devices to programmed with addresses that are automatically determined by slave devices (e.g., automatically determined based on the order in which the slave devices receive an address programming command). In this way, a host controller may be able to uniquely address devices in a daisy chain without requiring the slave devices to have factory-programmed device addresses.

### SUMMARY

This disclosure describes a technique for assigning device addresses to slave devices in a system comprising of a host controller and multiple slave devices that are connected in a daisy chain configuration. This disclosure also describes a protocol by which the host controller can communicate with any of the slave devices based on their assigned address or with certain subsets of the slave devices. Both the address assignment technique and the communication protocol utilize the single bus connecting the host controller and slave devices in a daisy chain configuration.

Disclosed herein is a slave device according to various embodiments, the slave device comprising: an upstream port connecting the slave device to an upstream device, wherein the upstream port receives an address assignment command from the upstream device, and wherein the address assignment command includes a first device address; an internal memory configured to store an assigned device address identifying the slave device; a logic unit operable to program the internal memory to store the first device address as the assigned device address and further operable to increment the first device address to generate a second device address and further operable to generate an updated address assignment command that includes the second device address; and a downstream port connecting the slave device to a downstream device, wherein the downstream port transmits the updated address assignment command to the downstream device.

According to various additional embodiments, the logic unit is further operable to generate an address assignment response command and further operable to transmit the address assignment response command to the upstream device via the upstream port. According to various additional embodiments, the downstream port receives a second address assignment response from the downstream device and wherein the upstream port transmits the second assignment response to the upstream device. According to various additional embodiments, the upstream device via a single wire and wherein the downstream port is connected to the downstream device via a single wire. According to various additional embodiments, the logic unit is further operable to determine if no downstream device is connected to the downstream port. According to various additional embodiments, the upstream port receives an address initialization command from the upstream device, and wherein the downstream port transmits the address initialization command to the downstream device. According to various additional embodiments, the logic unit is further operable to disconnect the downstream port upon transmitting the address initialization command to the downstream device and is further operable to reconnect the downstream port upon transmitting the address assignment response to the upstream device.

Also disclosed herein is a host controller device according to various embodiments, the host controller device comprising: a downstream port connecting the host controller to one or more downstream devices connected in a daisy chain via a single-wire communication bus, wherein the downstream port transmits an address assignment command, and wherein the downstream port receives address assignment responses from the one or more downstream devices; an internal memory configured to store address assignments and a logic unit operable to process the address assignment responses to determine a device address assignment for each of the one or more downstream devices and further operable to store the address assignments to the internal memory.

According to various additional embodiments, the address assignment command includes an initial device address. According to various additional embodiments, the address assignments for each of the one or more downstream devices are sequentially incremented addresses starting from the initial device address. According to various additional embodiments, the downstream port transmits a memory operation command, the memory operation command addressed to a first downstream device based on the stored address assignment for the first downstream device. According to various additional embodiments, the memory operation command specifies a memory location of the first downstream device.

Also disclosed herein is a slave device according to various additional embodiments, the slave device comprising: an upstream port connecting the slave device to an upstream device, wherein the upstream port is configured to receive a command from the upstream device, and wherein the command specifies one or more intended recipients; a downstream port connecting the slave device to a downstream device, wherein the downstream port is configured to transmit the command to the downstream device; an internal memory storing an assigned device address identifying the slave device, and a logic unit operable to determine whether the slave device is an intended recipient of the command based on the assigned device address.

According to various additional embodiments, the logic unit is further operable, if the slave device is not an intended recipient, to reconfigure the downstream port to receive a command response from the downstream device and to reconfigure the upstream port to transmit the command response to the upstream device. According to various additional embodiments, the logic unit is further operable, if the slave device is the only intended recipient, to generate a command response and to disable the downstream port and to reconfigure the upstream port to transmit a command response to the upstream device. According to various additional embodiments, the logic unit is further operable to determine whether the downstream device is an intended recipient of the command based on the assigned device address. According to various additional embodiments, the logic unit is further operable, if the slave device is an intended recipient and the downstream device is an intended recipient, to reconfigure the downstream port to receive a first command response from the downstream device and to reconfigure the upstream port to transmit the first command response to the upstream device. According to various additional embodiments, the logic unit is further operable, upon receiving the first command response from the downstream device and transmitting the first command response to the upstream device, to generate a second command response, and to reconfigure the upstream port to transmit the second command response to the upstream device and to disable the downstream port. According to various additional embodiments, the command includes calibration information specifying the baud rate used by the upstream device to transmit the command. According to various additional embodiments, the command specifies a device address identifying a single intended recipient.

Also disclosed herein is a method according to various embodiments for assigning unique device addresses to a series of devices, the method comprising: receiving an address assignment command from an upstream device, wherein the address assignment command includes a first device address; assigning the first device address to a device from the series of devices; incrementing the first device address to generate a second device address; generating an updated address assignment command, wherein the updated address assignment command includes the second device address; and transmitting the updated address assignment command to a downstream device.

According to various additional embodiments, the method further comprises: generating a first address assignment response command; and transmitting the first address assignment response command to the upstream device. According to various additional embodiments, the method further comprises: receiving a second address assignment response from the downstream device; and transmitting the second assignment response to the upstream device.

Also disclosed herein is a method according to various embodiments for communicating within a series of devices, wherein each device is assigned a unique identifier and wherein each device comprises a downstream port and an upstream port, the method comprising: configuring the upstream port of a device from the series of devices, wherein the upstream port is configured to receive communications from an upstream device; configuring the downstream port of the device to transmit communications to a downstream device; receiving a command from the upstream device, wherein the command specifies one or more intended recipients; transmitting the command to a downstream device; and determining whether the device is an intended recipient of the command.

According to various additional embodiments and if the device is not an intended recipient of the command, the method further comprises: reconfiguring the downstream port to receive a command response from the downstream device; and reconfiguring the upstream port to transmit the command response to the upstream device. According to various additional embodiments and if the device is the only intended recipient of the command, the method further comprises: disabling the downstream port; generating a command response; reconfiguring the upstream port to transmit communications to the upstream device; and transmitting the command response to the upstream device. According to various additional embodiments, the method further comprises: determining whether the downstream device is an intended recipient of the command based on the unique identifier of the device.

### BRIEF DESCRIPTION OF THE DRAWINGS

FIG. 1 is a schematic diagram illustrating a daisy chain system of devices according to various embodiments.

FIG. 2 is a schematic diagram illustrating a daisy chain system of devices according to various additional embodiments.

FIG. 3 is a schematic diagram illustrating one aspect of the operation of address programming according to various embodiments.

FIG. 4 is a schematic diagram illustrating another aspect of the operation of address programming according to various embodiments.

FIG. 5 is a schematic diagram illustrating another aspect of the operation of address programming according to various embodiments.

FIG. 6 is a schematic diagram illustrating another aspect of the operation of address programming according to various embodiments.

FIG. 7 is a schematic diagram illustrating another aspect of the operation of address programming according to various embodiments.

FIG. 8 is a schematic diagram illustrating another aspect of the operation of address programming according to various embodiments.

FIG. 9 is a schematic diagram illustrating another aspect of the operation of address programming according to various embodiments.

FIG. 10 is a schematic diagram illustrating another aspect of the operation of address programming according to various embodiments.

FIG. 11 is a schematic diagram illustrating another aspect of the operation of address programming according to various embodiments.

FIG. 12 is a schematic diagram illustrating certain aspects of a slave device according to various embodiments.

FIG. 13 is a schematic diagram illustrating certain additional aspects of the operation of a slave device according to various embodiments.

FIG. 14 is a schematic diagram illustrating certain additional aspects of the operation of a slave device according to various embodiments.

FIG. 15 is a schematic diagram illustrating certain additional aspects of the operation of a slave device according to various embodiments.

FIG. 16 is a schematic diagram illustrating certain additional aspects of the operation of a slave device according to various embodiments.

FIG. 17 is a block diagram illustrating the byte structure utilized by a host controller for messaging according to various embodiments.

FIG. 18 is a diagram illustrating a typical calibration byte utilized by a host controller according to various embodiments.

FIG. 19 is a block diagram illustrating the structure of a command byte utilized by a host controller for messaging according to various embodiments.

FIG. 20 is a schematic diagram illustrating certain aspect of the operation of a messaging protocol according to various embodiments.

FIG. 21 is a schematic diagram illustrating certain additional aspect of the operation of a messaging protocol according to various embodiments.

FIG. 22 is a schematic diagram illustrating certain additional aspect of the operation of a messaging protocol according to various embodiments.

FIG. 23 is a schematic diagram illustrating certain additional aspect of the operation of a messaging protocol according to various embodiments.

FIG. 24 is a flowchart illustrating certain steps of an address programming procedure according to various embodiments.

### DETAILED DESCRIPTION

Embodiments now will be described more fully hereinafter with reference to the accompanying drawings. Aspects of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art such that one skilled in the art may be able to use the various embodiments.

This disclosure describes techniques and communication protocols that may allow a host controller to communicate with each a plurality of slave devices that are coupled to the host controller in a daisy chain configuration. In some example daisy chain configurations, each device can directly communicate only with neighboring devices. In such examples, a host controller can directly communicate only with a single of the slave devices in the daisy chain. This disclosure describes a protocol by which the host can communicate with any slave device in the daisy chain, while utilizing only the daisy chain connections that link the individual slave devices. In order to communicate with the individual slave devices, the host controller may need to uniquely identify each of the slave devices. Thus, each slave device may be associated with a unique identifier and the host may be informed of the unique identifier used by each slave device in the daisy chain.

One approach to configuring a daisy chain with unique identifiers is for slave device manufacturers to provide a factory programmed unique address for each individual slave device. One disadvantage of this approach is that it places an artificial limit on the maximum number of devices that can be put in the daisy chain network. For many types of relatively low-cost slave devices, such as sensors, it may be a burden for manufacturers of such devices to maintain separate manufacturing flows for devices with different factory programmed unique addresses. Due to this burden, manufacturers may only support a limited number of different device address options (e.g., ten different addresses), which may be too low for certain applications, for instance large networks of sensors.

Even if a manufacturer is willing to support a sufficient number of device addresses, utilizing factory programmed devices is also burdensome on the customer that is assembling the device components into the daisy chain configuration. On a logistical level, the customer may need to implement systems capable of managing otherwise identical devices according to their different device addresses. The customer may need to accurately order and track these devices based on their different addresses and ensure that manufacturing systems are provided with the correct device and the correct address associated with the device.

The use of factory programmed addresses may pose addition burdens to the manufacturing processes. During both the design and assembly of a daisy chain of such devices, the manufacturing process may need to correctly track the different devices based on their hard-coded device address in order for the system to be manufactured and operate correctly. Also testing systems may be used to ensure that each device is correctly located based on its device address. Systems for diagnosing and repairing failures are likewise effected as a customer may implement processes capable of identifying failed devices based on their device address and replacing the defective device with another device that utilizes the same device address or otherwise reprogramming the daisy chain to utilize a different address for the device at the location of the replacement.

Another possible mechanism for providing addresses to slave devices in a daisy chain configuration is for each device to provide an address pin that is configured to receive an address assignment. Using an address pin may require that each device be configured to process address pin commands. Using one or more dedicated address pins also places an artificial limit on the max number of devices in the application as adding pins increases die area incrementally and package size exponentially, thereby increasing the cost of the device significantly.

Certain systems implemented using daisy chained devices may use only a single wire be used to link the devices. Such systems may be limited to a single wire due to factors such as cost and/or board space. Certain conventional approaches for linking daisy chained devices utilize a return wire that runs from the terminal device in the chain back to the host controller on the other end of the chain. This approach simplifies certain aspects of the communications by the slave devices and the host controller, but is not feasible due to the extra cost and complexity that may be attendant with a return wire.

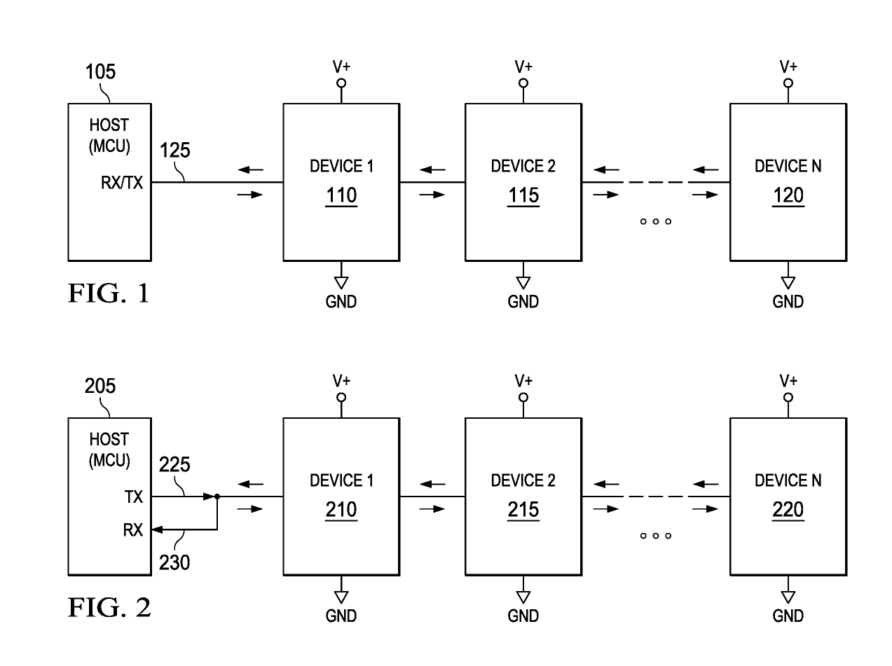

FIG. 1 depicts a system according to certain embodiments where a set of slave devices 110, 115, 120 is connected in a daisy chain configuration to a host controller 105 via a single pin 125 of the host controller. As a daisy chain configuration, each device is connected to exactly two neighboring devices, except for the host controller 105 and the final slave device 120 in the chain, which are connected to a single neighbor. The host controller 105 sends commands to the slave devices 110, 115, 120 via the single communication bus forming the daisy chain connection between the devices. As described above, in order for the host controller 105 to communicate with each of the slave devices 110, 115, 120, the host controller may use a unique device address for each of the slave devices. Using these unique addresses, the host controller 105 is able to issue commands to each of the slave devices 110, 115, 120, despite being connected to only slave device 110 via the single wire communication bus 125. Consequently, each of the slave devices 110, 115, 120 is configured to monitor the communication bus and participate in forwarding messages intended for upstream devices and downstream devices in the daisy chain.

FIG. 2 depicts an alternative embodiment where the host controller 205 utilize two pins 225, 230 to communicate with the slave devices 210, 215, 220 via the single wire bus connecting the devices. In the system of FIG. 2, the host controller 205 utilizes one pin 225 for transmissions and another pin 230 for receipt of communications. Such a configuration utilizing separate input and output pins allows the host controller 205 to be configured as a UART (Universal Asynchronous Receiver/Transmitter) controller, thus utilizing existing UART communication capabilities already present in certain controllers. Configured as a UART controller, the host controller 205 can utilize the UART packet structure to transmit and receive data on the communication bus.

Referring back to the system of FIG. 1, the host controller 105 communicates with each of the slave devices 110, 115, 120 using the unique device address of each slave device. Rather than utilizing fixed unique device addresses provided by the manufactures of the slave device, as described above, embodiments assign unique addresses to each slave device 110, 115, 120 when the daisy chain system is initialized for the first time. Thus, via the single-wire communication bus linking the daisy chained devices to the host controller 105, each slave device 110, 115, 120 is assigned a unique device address based on a starting device addressing that is specified by the host controller 105 and assigned to the first slave device 110 in the chain. This address programming process can be performed by the manufacturer of the daisy chained system a single time when the system is initialized, without requiring any address assignment in the field.

FIG. 12 illustrates certain components of a slave device 1205 according to various embodiments. As described above, the slave device 1205 is connected in daisy chain configuration to two devices, one upstream device and one downstream device. A single wire communication bus is used to connect the daisy chained devices. The slave device 1205 has an upstream port 1210 (also denoted as “I/O 1”) that is closest to the host controller that terminates one end of the daisy chain. The slave device 1205 also has a downstream port 1215 (denoted as “I/O 2”). The slave device 1205 receives commands on the upstream port 1210 and the downstream port 1215 and processes the received commands using a logic unit 1220. Based on the processing of the received commands, the logic unit 1220 may configure the slave device 1205 in one of four different operating modes. These operating modes dictate the behavior of slave device 1205 in processing and routing commands received on the upstream port 1210 and the downstream port 1215.

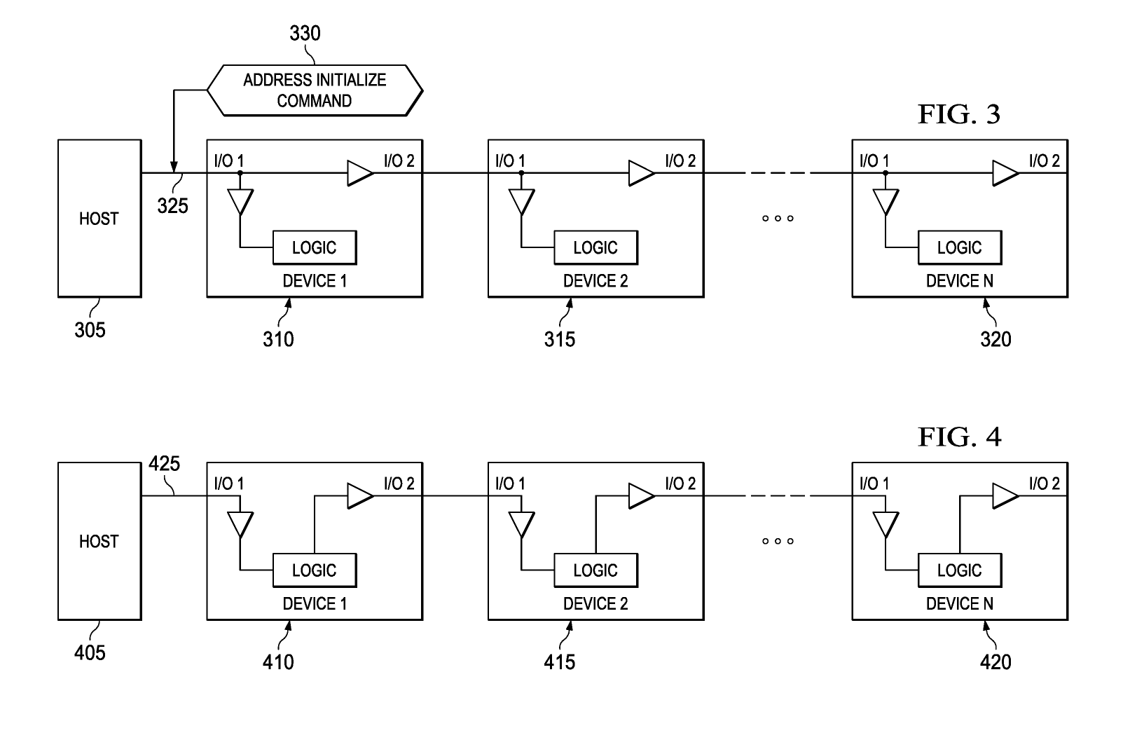

FIG. 3 illustrates the initialization of an address programming scheme, according to various embodiments, for a system of devices connected in a daisy chain configuration using as single communication bus 325. This first step initiates the assignment of unique device addresses to each of the slave devices 310, 315, 320. The upstream port of the first slave device 310 is connected directly to the host controller 305 via the communication bus 325. The second device 315 is connected to the host controller 305 indirectly via the communication bus 325 connection to the first device 310, this indirect connection utilizing the upstream port of the second device 315 and the downstream port of the first device 310. In this manner, any number of slave devices may be added to the daisy chain and thus linked indirectly to the host controller 305.

In the addressing scheme illustrated in FIG. 3, each of the slave devices 310, 315, 320 is configured to participate in forwarding data to its neighboring devices. In particular, each of the slave devices 310, 315, 320 is configured to receive commands from an upstream device (or, in the case of the first slave device 310, from the host controller 305) on its upstream port and forward the commands to a downstream device via its downstream port. Likewise, each of the slave devices 310, 315, 320 is also configured to received commands from a downstream device via its downstream port and forward the command to an upstream device (or, in the case of the first slave device 310, to the host controller 305) via its upstream port.

The behavior of each of the slave devices 310, 315, 320 in forwarding commands to neighboring slave devices is determined according to the current operating mode of the slave device, with different operating modes providing different forwarding and processing operations by the slave device. Using these modes, the daisy chain of slave devices 310, 315, 320 is configured by the host controller 305 via a series of commands transmitted via the communication bus 325 linking the devices. Each of the slave devices 310, 315, 320 is configured to identify commands issued by the host controller 305 that direct the slave devices to change to a different mode of operation.

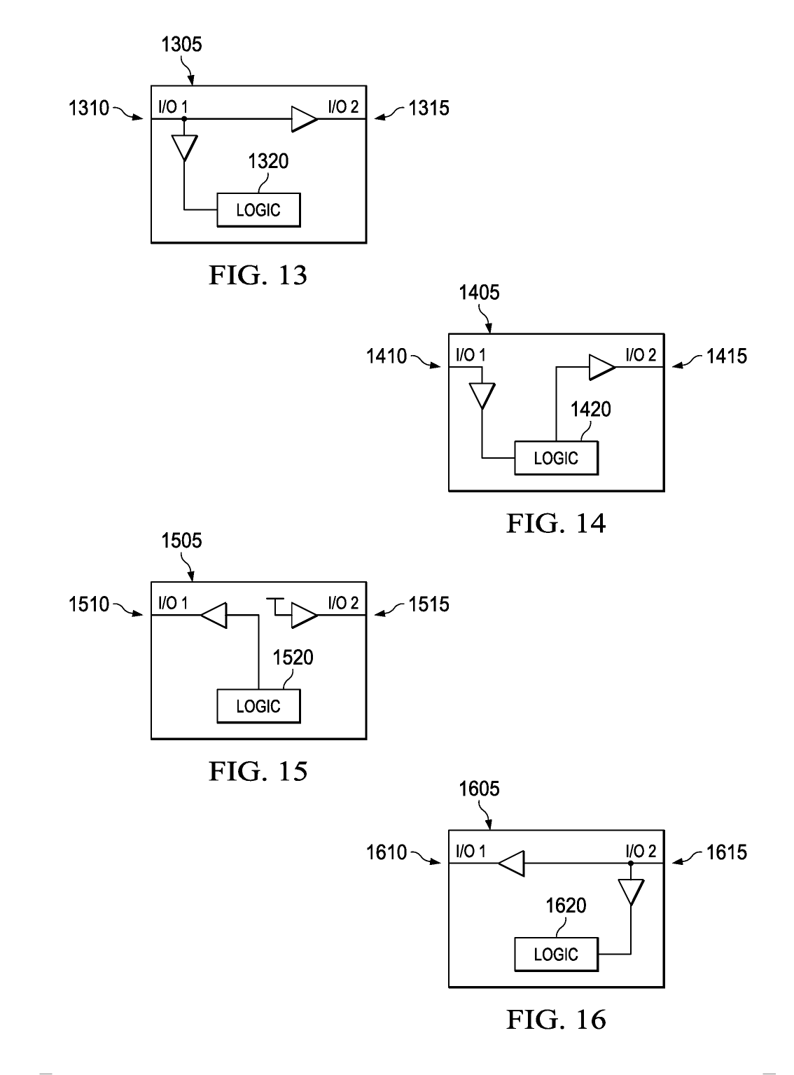

By default, the slave devices 310, 315, 320 are configured to begin operation in a forward pass-through mode. A slave device configured in forward pass-through mode is illustrated in FIG. 13. In this mode, a slave device 1305 is configured to receive commands on the upstream port 1310. The received command is read to an internal memory of the slave device for processing by the logic unit 1320. The received command is also forwarded to the neighboring downstream device connected via the downstream port 1315. The slave device 1305 remains connected to the communication bus at both the upstream and downstream ports during forward pass-through mode. Based on the reading of the received command, the slave device may reconfigure itself to a different mode of operation or may remain in forward pass-through mode.

Referring back to FIG. 3, the address programming scheme begins with the host controller 305 issuing an address initialization command 330 to the first slave device 310. Configured in forward pass-through mode, the first slave device 310 reads the address initialization command to memory and forwards the command to the second slave device 315, which in turn reads the command to memory and forwards it to the third device 320. Upon forwarding the command to its neighboring downstream device, each of the slave devices 310, 315, 320 reads the command from memory and processes the command via an internal logic unit. In the illustrated scenario, based on this processing, each of the slave devices 310, 315, 320 determines that the received command is an address initialization command.

As illustrated in FIG. 4, in response to receipt of an address initialization command, each of the slave devices 410, 415, 420 switches from forward pass-through mode to forward controlled mode. Configured in forward controlled mode, each of the slave devices 410, 415, 420 disconnects its downstream port from the communication bus 425. The host controller 405 remains connected to the first slave device 410 and thus still maintains control of the daisy chained network of devices. With each of the slave devices 410, 415, 420 in forward controlled mode, the host controller 405 continues the address programming procedure by issuing an address assignment command to the first slave device 410.

As illustrated in FIG. 14, in forward controlled mode, a slave device 1405 is configured to receive input commands on its upstream port 1410, process the received command using the logic unit 1420 in order to generate an output command. The generated output command is then directed to the neighboring downstream device via the downstream port 1415 of the slave device. Accordingly, the slave device 1405 remains connected to the communication bus at its upstream port 1410, but the communication bus at its downstream port 1415 is connected to the logic unit 1420, from which an output command will be issued. Once the output command has been issued, the input command may be further processed by the logic unit 1420. Based on the processing of the received input command, the slave device 1405 may remain in forward controlled mode or may change to a different mode.

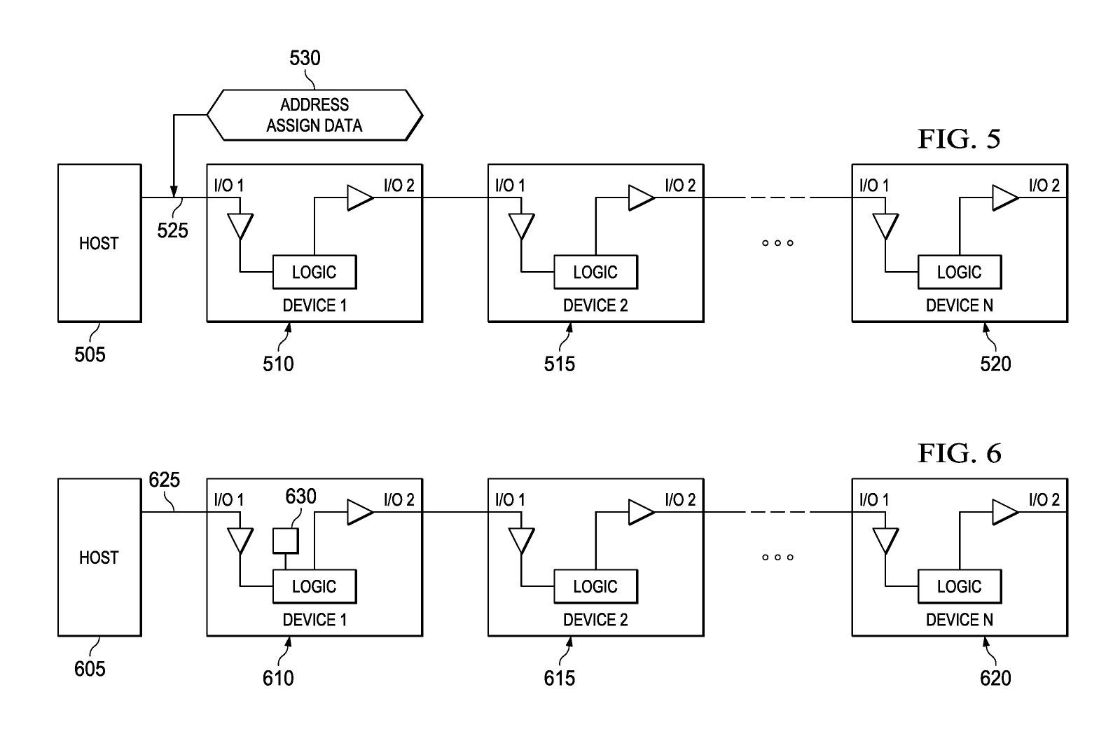

Referring back to FIG. 5, the host controller 505 issues an address assignment command 530 to the first slave device 510 in order to initiate assignment of a unique address to each of the connected slave devices 510, 515, 520, each of which is in forward controlled mode. The address assignment command 530 issued by the host controller 505 includes an address value. The first slave device 510 processes the received command and determines it is an address assignment command. Based this determination, the first slave device will set its device address to the provided address value. As illustrated in FIG. 6, the first slave device 610 programs the assigned address in its internal memory 630. The first slave device 610 also increments the provided address value to generate a different address which will be assigned to its neighboring downstream device 615.

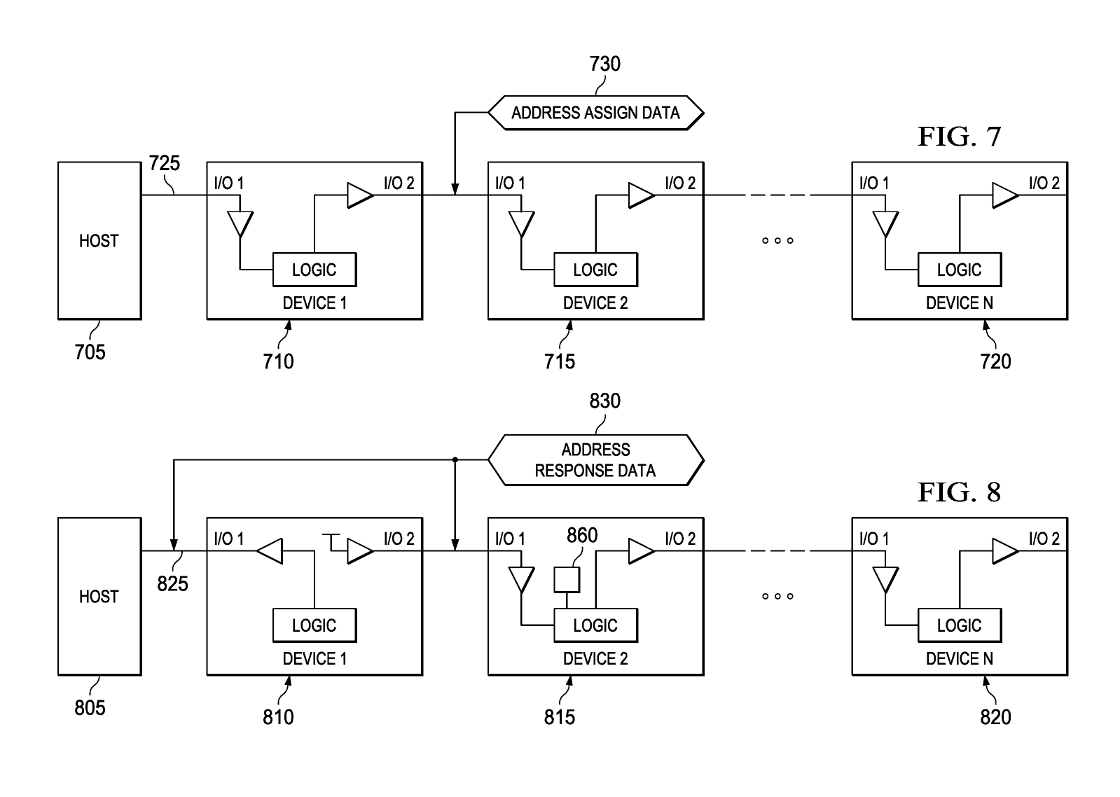

The address programming scheme continues, as illustrated in FIG. 7, with the first slave device 710 generating an address assignment command 730 and dispatching the generated command on its downstream port to the second slave device 715. The address assignment command 730 generated by the first slave device 710 includes the incremented device address. At this point, the slave devices 710, 715, 720 are still in forward controlled mode.

As illustrated in FIG. 8, upon dispatching the address assignment command to the second slave device 815, the first slave device 810 switches from forward controlled mode to reverse controlled mode. As illustrated in FIG. 15, in reverse controlled mode, a slave device 1505 is configured to dispatch a command upstream. In this mode, the logic unit 1520 of the slave device 1505 is configured to generate a command. The generated command is dispatched via the upstream port 1510 and the downstream port 1515 is disconnected from the communication bus while the command is transmitted upstream.

Referring back to FIG. 8, the first slave device, now configured in reverse controlled mode, generates an address response command 830 that is dispatched back to the host controller 805 via the communication bus 825. Via this address response command 830, the first slave device 810 acknowledge that it has received the provided device address. The acknowledgement further signals that the first slave device 810 has successfully programmed the device to its internal memory 860 and will respond to commands directed to the provided address.

Also illustrated in FIG. 8, the address assignment command issued by the first slave device 810 is received by the second slave device 815, which processes the received the address assignment command to determine the device address that it has been assigned. The second slave device 815 programs the assigned address to its internal memory and is now configured to respond to commands directed to this assigned address. As with the first slave device 810, the second slave device 815 increments the received address to generate a different device address which will be forwarded to the third slave device 820 using an address assignment command. The third device 820 and each device in the chain after the third device repeats this process of programming a received address as its device address, incrementing the received address to generate a different address and forwarding the incremented address to the next downstream slave device as an address assignment command. In this manner, a large number of slave devices can be programmed with unique device address using only a single command that is issued by host controller 810 along a single-wire communication bus linking the slave devices in a daisy chain configuration.

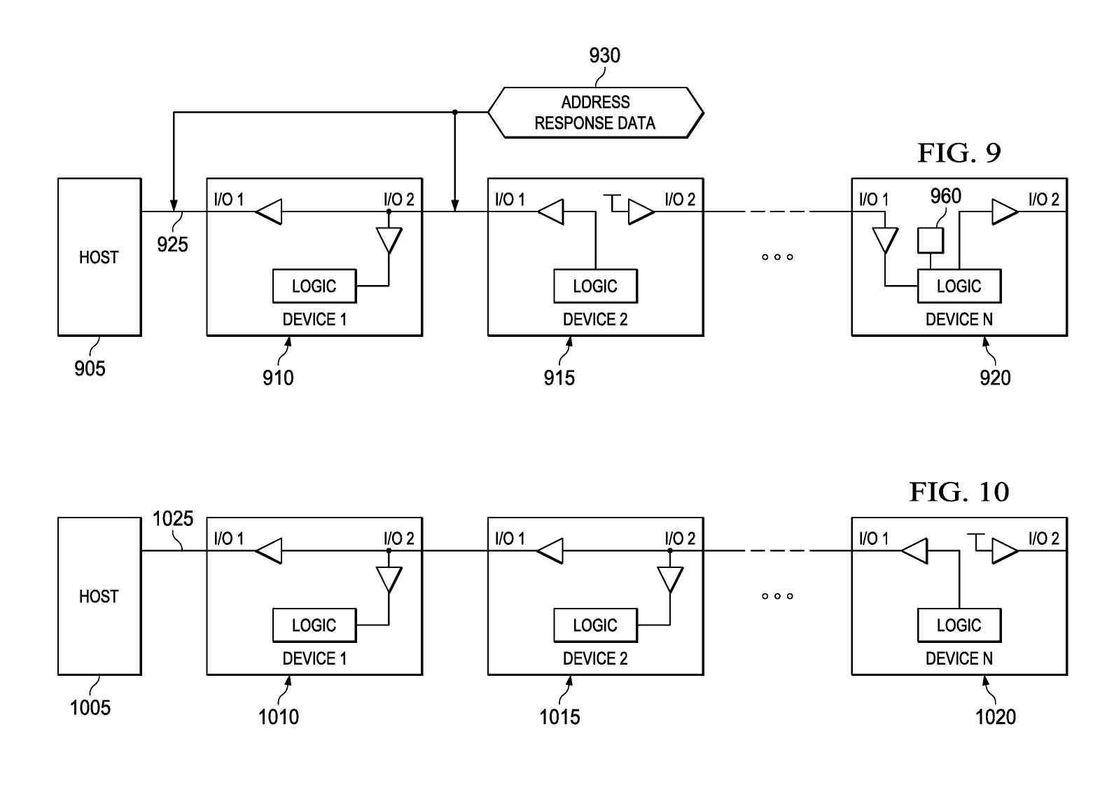

Address programming continues as illustrated in FIG. 9. Upon sending the address response command to the host controller 905, the first slave device 910 switches from reverse controlled mode to reverse pass-through mode. As illustrated in FIG. 16, in reverse pass-through mode, a slave device 1605 is connected to the communication bus at both the upstream port 1610 and the downstream port 1615. A slave device 1605 configured to operate in reverse pass-through mode receives commands on the downstream port 1615, reads the command to memory using the logic unit 1620, and forwards the received command to the neighboring upstream device connected via the upstream port 1610. Based on the reading of the received command, the slave device may reconfigure itself to a different mode of operation or may remain in reverse pass-through mode.

As depicted in FIG. 9, the second slave device 915, after dispatching an address assignment command to the third slave device 920, also switches from forward controlled mode to reverse controlled mode. Configured in reverse controlled mode the second slave device 915 issues an address response command that will signal receipt of the assigned address to the host controller 905. Configured in reverse pass-through mode, the first slave device 910 receives the address response command from the second slave device 915 and forwards it on its upstream port to the host controller 905. The third slave device 920, still in forward controlled mode, receives its address assignment and programs the assigned address to its internal memory 960.

As illustrated in FIG. 10, after reporting its assigned device address to the host controller 1005, the second slave device 1015 switches from reverse controlled mode to reverse pass-through mode. Configured in this manner, the second slave device 1015 is ready to relay an address confirmation command from the third slave device 1020 upstream towards the host controller 1005. As with the prior two slave devices, upon dispatching an address assignment command on its downstream port, the third slave device 1020 configures itself in reverse controlled mode and dispatches an address confirmation command to the second slave device 1015. This address confirmation is then forwarded upstream by both the second slave device 1015 and the first slave device 1010, both configured in reverse pass-through mode, until it reaches the host controller 1005. Even though it is the terminal slave device in the daisy chain, the third slave device 1020 attempts to assign an address to a downstream device. Consequently, the third slave device 1020 increments its assigned address in order to generate a different address for assignment to a downstream device.

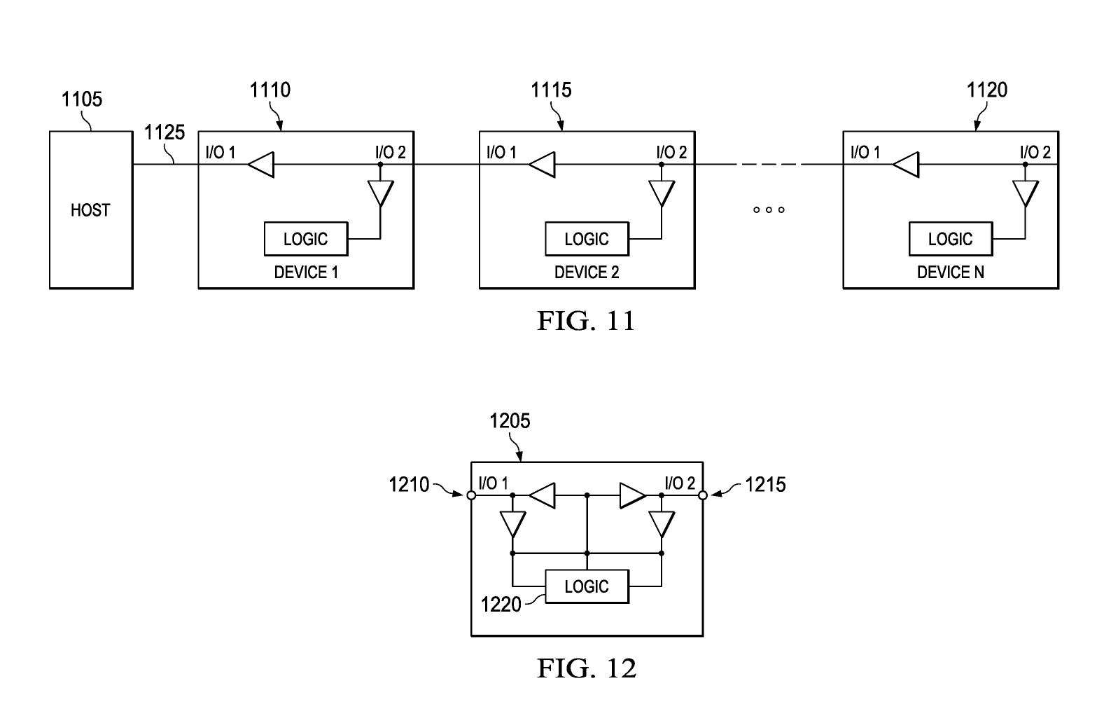

As illustrated in FIG. 11, as with the prior two slave device, the third slave device 1120 configures itself in reverse pass-through mode upon dispatching its address confirmation command upstream. As the terminal slave device in the chain, however, the third slave device 1120 does not receive an address confirmation command from a downstream device. Each of the slave devices 1110, 1115, 1120 is configured to detect a failure to receive at least one address confirmation command in response to an outgoing address assignment command. Under normal operations, only the third slave device 1120, being the terminal device, will detect a failure to receive an address confirmation command in response to an address assignment command.

In certain embodiments, upon determining a failure to receive an address confirmation from a downstream device, the third slave device 1120 signals an end-of-procedure condition to the second slave device 1115 and switches to the default forward pass-through mode. Upon receiving the end-of-procedure signal, the second slave device 1115 repeats this process of forwarding the signal and reverting to forward pass-through mode. Each slave device repeats the process until the daisy chain is configured again as illustrated in FIG. 3. The receipt of the end-of-procedure signal at the host controller 1105 completes the address programing procedure such that each device in the daisy chain has a unique device address that is based on its position in the chain.

According to certain embodiments, the third slave device 1120 programs itself as the terminal device on the communication bus upon detecting that is the final slave device in the daisy chain. In the illustrated embodiment, the third slave device 1120 stores a bit in a specified register that identifies it as the terminal device. Other embodiments may utilize other mechanisms for programming this terminal device identification by the terminal device. The terminal device identifier may be utilized in certain commands issued by the host controller where the processing of these commands may involve special processing by the terminal device in the chain.

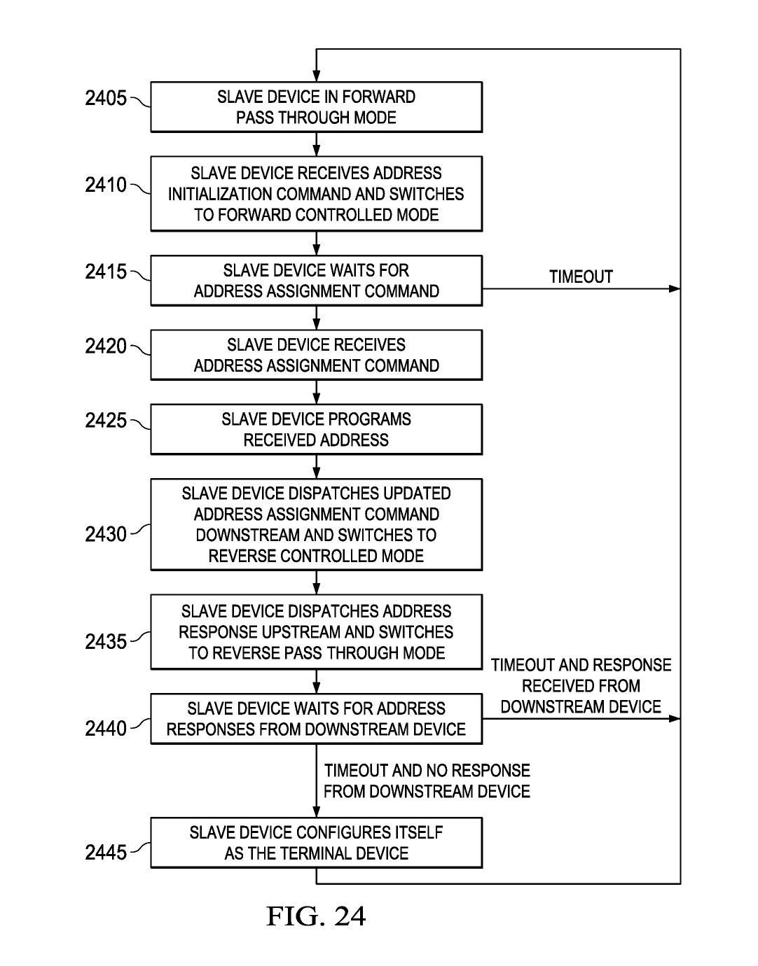

This address programming process is further illustrated in the flowchart of FIG. 24. Initially 2405, each slave devices is configured in forward pass-through mode and is ready to receive a command from an upstream device which may be a slave device or a host controller. Address programming is initialized with the receipt 2410 of an address initialization command from the host controller. Upon receipt of this command, a slave device switches to forward controlled mode and proceeds to wait 2415 for an address assignment command from an upstream device. If no address assignment is received within a certain time limit, the address assignment process times out and the device reverts 2405 to forward pass-through mode. Upon receipt 2420 of an address assignment command, the slave device programs 2425 the address received in the address assignment command to its internal memory. The slave device increments the received address and dispatches 2430 an updated address assignment command to downstream devices. The slave device switches to reverse controlled mode while dispatching 2435 an address response command upstream in order to confirm address assignment to the host controller. Upon dispatching 2435 the address response, the slave device switches to reverse pass through mode and waits 2440 for address responses from downstream devices. If responses are received, the response is forwarded upstream by the slave device, which remains in reverse pass through mode. When no further responses are received within a certain time limit, the slave device exits the assignment procedure and reverts 2405 to forward pass-through mode. If no address response is received from any downstream device, the slave device determines 2445 that it is the terminal device in the chain and configures itself accordingly. The slave device then reverts to forward pass-through mode 2405.

In this manner, any number of slave devices can be linked in a daisy chain and configured to receive an address assignment. Each slave device is further configured to generate a new address based on the address it receives and assign the generated address to a downstream device. Configured as such, each slave device in the daisy chain is assigned a unique device address with respect to this particular system of devices. Each slave device is further configured dispatch an address response command upstream and participate in forwarding address responses received from downstream devices. Each slave device reports its assigned address to the host controller using an address response command. The host controller is configured to receive the address confirmation commands from each of the slave devices. The host controller processes these confirmations to track the device address received and programmed by each of the slave devices. Using this information, the host controller can address a command to any slave device in the daisy chain. The host controller can optimize its internal operations by taking advantage of the correlation between a slave device's position in the chain and its assigned device address relative to the starting address issued by the host controller to the first slave device.

The ability to program unique addresses to any number of slave devices in this manner obviates the need for slave devices to be provided with factory programmed addresses. As described above, providing factory programmed addresses places a significant burden on device manufactures and system integrators utilizing these devices. Addressing a set of slave devices utilizing embodiments maintains greater flexibility in the number of slave devices that can be supported and simplifies manufacturing and logistical processes that would otherwise be necessary to track slave devices according to their factory assigned address. The lack of factory programmed addresses also allows system designers to easily replace a slave device in the daisy chain. Once a faulty device is replaced, the slave devices are reset and the address programming scheme is re-initialized. This improves the ability to quickly replace malfunctioning slave devices during testing.

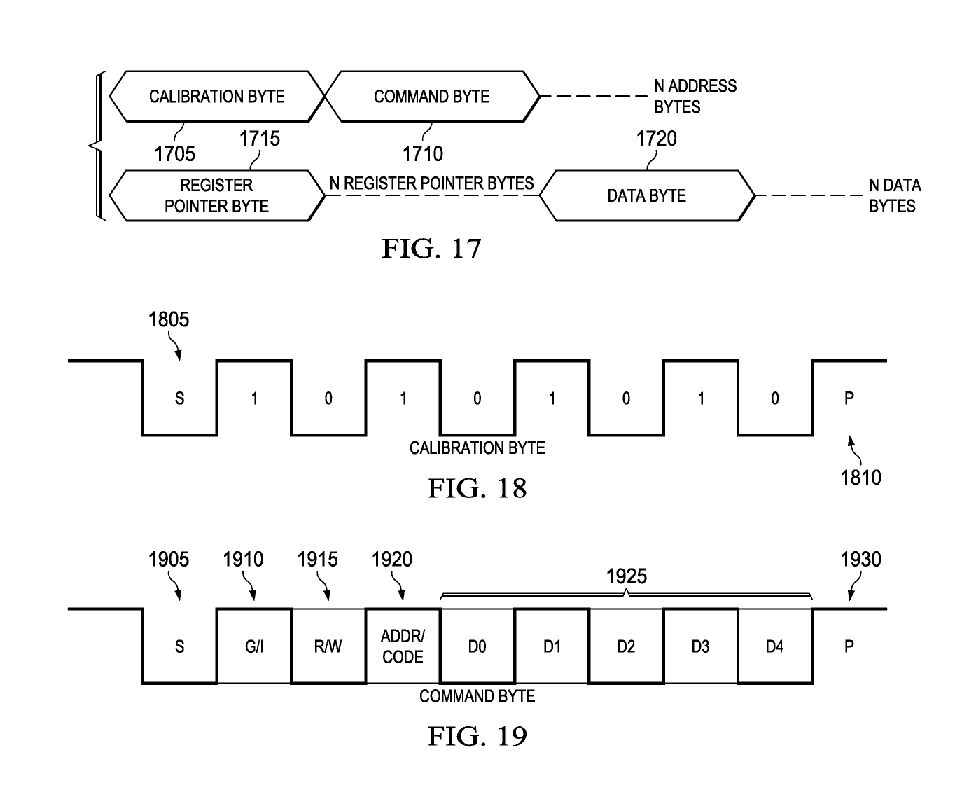

Once the slave devices of the daisy chain have been addressed and the host controller has received confirmation of each slave device address assignment, the host controller may begin communicating with each of the slave devices. According to various embodiments, the host controller is configured to utilize the byte structure illustrated in FIG. 17 to transmit communications to the slave devices. The slave devices that form the daisy chain are likewise configured to receive communications encoded using the byte structure illustrated in FIG. 17.

In the embodiment of FIG. 17, the byte structure of each host controller communication begins with a calibration byte 1705. The calibration byte is used to establish the baud rate that will be used for the remaining portion of the host controller communication that follows the calibration byte. In certain embodiments, each host controller communication begins with a calibration byte, thus enabling the use of different baud rates for individual host controller communications. Other embodiments may operate without utilizing a calibration byte, for instance where the host controller and slave devices all operate at the same, fixed baud rate. Other embodiments may utilize a calibration byte only when switching the baud rate being utilized by the host controller. The ability to vary the baud rates for each host controller communication provides an improvement over conventional, single-wire bus protocols that may require the use of a single, fixed baud rate. By supporting variable baud rates, different host controllers may be utilized without requiring any reconfiguration of the slave devices other than the processing of a new calibration byte.

FIG. 18 illustrates a typical calibration byte according to certain embodiments. In the illustrated embodiment, the beginning of a calibration byte is signaled to the slave devices by a start signal 1805 that pulls the voltage low on the single wire communication bus. Following the start signal 1805, the host controller transmits a bit sequence on the communication bus at the desired baud rate. The host controller signals the end of the bit sequence using an end signal 1810. In the illustrated embodiment, the end signal 1810 pulls the voltage high on the communication bus.

The slave devices connected to the host controller are configured to receive calibration bytes, such as the typical byte illustrated in FIG. 18, and configure themselves accordingly. Each slave device detects the start signal 1805 of the calibration byte on the communication bus and proceeds to receive the bit sequence that encodes the baud rate being specified by the host controller. Each slave device detects the end signal 1810 and, based on the received bit sequence, calculates the baud rate being specified by the host controller. The slave devices may then be configured to receive the remaining portion of the host controller communication at the specified baud rate.

In the embodiment illustrated in FIG. 17, the calibration byte is followed in a host controller communication by command byte 1710. In embodiments that do not utilize a calibration byte, a host controller communication may begin with a command byte. The structure of a command byte according to various embodiments is illustrated in FIG. 19. The illustrated command byte begins with a start signal 1905. In the illustrated embodiment, the start signal 1905 consists of pulling the voltage low on the communication bus. Next, the command byte specifies a bit sequence 1910 specifying whether the communication represents a global or individual command. If the command is global, the command is directed at all slave devices in the daisy chain, or in some embodiments, a subset of the slave devices in the chain. If the command is individual, the command is directed at a single slave device that is specifically identified by its unique address. Next, the command byte includes a bit sequence 1915 that specifies whether the command specifies a read operation or a write operation. In a read operation, the host controller is retrieving data stored at a specific address of a slave device. In a write operation, the host controller is writing data to a specific address of a slave device.

Next, the command byte includes a bit sequence 1920 that specifies whether a device address or a command instruction will be provided in the following bit sequence 1925 of the command byte. If the bit sequence 1920 indicates a device address will follow, the subsequent bits 1925 provide the unique address assigned to a particular slave device. This ability to specify the unique address of a device using bit sequences 1920 and 1925 is utilized when bit sequence 1910 specifies that the command is directed to a specific slave device. In the embodiment illustrated in FIG. 19, five bits 1925 are used to specify a device address or command instruction. Other embodiments may use different numbers of bits for this purpose, thus providing the ability to specify a unique address for a large number of slave devices.

The bit sequence 1920 of the command byte may also be used to indicate that a command instruction will be provided in the following bit sequence 1925. If a command instruction is provide in bit sequence 1925, this command instruction directs all of the slave devices that receive the command to carry out a specific function, such as a software reset or changing the status of an interrupt pin. The command ends with an end signal 1930 that follows the bit sequence 1925 that specifies a device address or command instruction. In the illustrated embodiment, the end signal 1930 consist of pulling the voltage high on the single-wire communication bus.

In the byte structure of a host controller communication illustrated in FIG. 17, the command byte 1710 is followed by a register pointer byte 1715. The host controller uses the register pointer byte 1715 to specify the address of a memory register. This memory register address may correspond to a register located at a single slave device or a memory register that is found on multiple of the slave device. The host controller will either read or write data at the location specified by the register pointer byte 1715. Referring back to FIG. 19, the slave device that provides the register specified by the register pointer byte is identified in the bit sequence 1925 of the command byte. Whether data will be read or written at the register location is specified by bit sequence 1915 of the command byte.

Referring back to FIG. 17, in scenarios where the command byte 1710 does not specify a read or write operation and thus does not include a device address, no register pointer byte 1715 is included in the host controller communication. Accordingly, in scenarios where the command byte 1710 does not specify a read or write operation, the host controller communication terminates with a command byte 1710. In certain embodiments, multiple register bytes may be provided in a host controller communication, thus specifying a read or write to multiple memory locations. In certain embodiments, the register pointer byte may be used to address other forms of memory besides registers located on the slave devices.

In the embodiment of FIG. 17, the register pointer byte 1715 is followed by a data byte 1720. One or more data bytes may be provided in the host controller communication. In scenarios where the command byte 1710 specifies a write command, the data byte 1720 provides the data that is written to the memory location specified by the register pointer byte 1715. In scenarios where the command byte 1710 specifies a read command, no data byte 1720 is included in the host controller communication and the terminal component of the communication is the register pointer byte 1715. In scenarios where the command byte 1710 specifies a write operation, the data byte 1720 is the final component of the host controller communication.

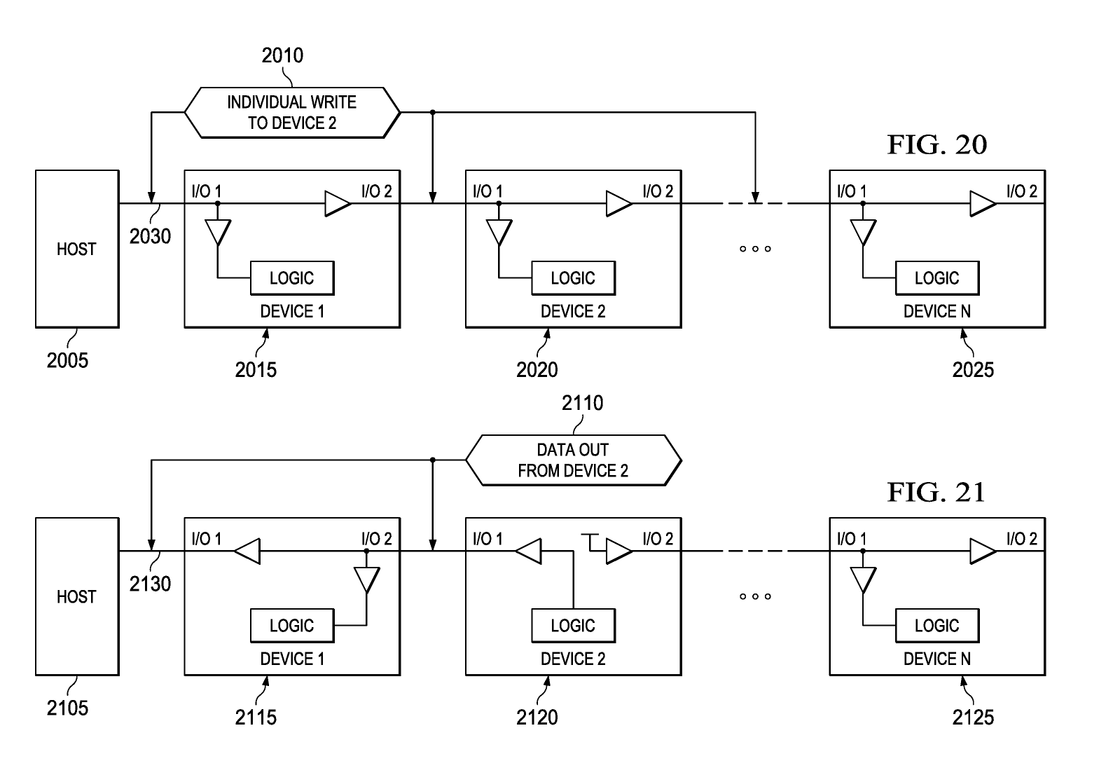

Utilizing the byte structure illustrated in FIG. 17 and the slave device operating modes described above, the host controller can issue various types of read and write commands to the slave devices in the daisy chain. FIG. 20 illustrates the operation of the host controller 2005 dispatching a communication 2010 that is directed to an individual slave device 2020, where the communication is an individual write command. The individual write command 2010 is specified by the host controller 2005 via a command byte that includes bit sequences signaling a command to an individual slave device, and further signaling a write operation and providing the unique device address of slave device to which the individual command is directed. The host controller 2005 dispatches a host controller communication that includes this command byte via the single wire communication bus 2030 that connects the slave devices 2015, 2020, 2025.

As illustrated, slave devices 2015, 2020, 2025 are configured in forward pass-through mode such each slave device receives the write command 2010, reads the command and forwards the write command to the downstream slave device via the communication bus. The first slave device 2015 receives the write command 2010, parses the command byte and determines that an individual write command is specified, but the device address specified by the command byte command is different from the device address of the first slave device 2015. Since the write command 201 is individual command not addressed to the first slave device 2015, the first slave device takes no further action.

The second slave device 2020 receives the write command 2010 on the communication bus, reads the command and forwards the command downstream to the third slave device 2025. The second slave device 2020 processes the write command 2010 and determines that that the device address specified in the command byte matches the device address assigned to the second slave device. The second slave device 2020 processes the write command 2010 further to extract the address location encoded in the register pointer byte. In some embodiments, multiple register pointer bytes will be included in the write command 2010. The second slave device 2020 processes the data byte of the write command 2010 to extract the data provided by the host controller. In some scenarios, multiple data bytes will be included in the write command 2010. The second slave device 2020 stores the data to the register specified by the register pointer byte.

As describe with respect to FIG. 19, a command byte may specify that a command issued by the host controller is directed globally to all slave devices in the daisy chain. As with an individual write command, the slave devices begin in forward pass-through mode in scenarios where a global write command is issued. Each slave device processes the byte command to determine that a global write command has been specified. Each slave device parses the register pointer byte and data byte of the write command. Each slave device then stores the extracted data to a register specified by the register pointer byte.

In scenarios where a global write command is issued to all devices in the chain, no device address is specified in the byte command. In certain embodiments, however, a global write command may be issued to a subset of the slave devices by including a device address in a global write command. In certain of such embodiments, each slave device processes the command to determine if its assigned address is less than or equal to the specified device address. If a slave device determines its assigned address is less than or equal to the specified address, the slave device responds to the command by writing the provided data to the specified memory location. In certain other embodiments, slave devices will respond if their device address is greater than or equal to the specified address. In this manner, the host controller can rely on the sequential device addresses assigned as describe above to address a command to a portion of the device chain.

This ability to direct a global command to subset of slave devices while only providing a single device address in the command is possible due to the position-based address programming scheme described above. Each slave device can easily determine whether it is located upstream or downstream from any given device based only on address information. Additionally, each slave device is able to easily determine its relative position from the host controller, the terminal slave device or any other device in the daisy chain.

The host controller may further utilize the byte structure illustrated in FIG. 19 to issue read commands directed to individual slave devices. As with the write commands, the slave devices are in forward pass-through mode when a read command is issued by the host controller. Each slave device processes the command to determine, based on the device address specified in the byte command, whether it is the intended recipient of the read command. In the embodiment illustrated in FIG. 21, an individual read command has been issued by host controller 2105 to the second slave device 2120

The first slave device 2115 receives the command and reads it to memory. The first slave device 2115 forwards the command downstream to the second slave device 2120. The first slave device 2115 processes the command and determines it is an individual read command that is directed to a slave device located downstream from the first slave device. Based on this determination, the first slave device 2115 switches from forward pass-through mode to reverse pass-through mode. Configured in this fashion, the first slave device 2115 is configured to cooperate in forwarding the requested data to the host controller.

Upon receipt of the forwarded command, the second slave device 2120 forwards the command downstream, processes it and determines it is an individual read command that is directed to the second slave device. Based on this determination, the second slave device 2120 switches from forward pass-through mode to reverse controlled mode. As illustrated, the third slave device 2125 receives the forwarded command, processes it and takes no action upon determining that it is an individual command directed to an upstream slave device. The second slave device 2120 processes the read command further to extract the register address encoded in the register pointer byte. The second slave device 2120 reads the data from the specified memory address and dispatches the retrieved data upstream to the host controller via a data response 2110 sent to the first slave device 2105. Upon dispatching the data response 2110, the second slave device 2120 switches back to forward pass-through mode. The first slave device 2115 receives the data response 2110. Configured in reverse-pass through mode, the first slave device 2115 forwards the data response 2110 upstream to the host controller 2105 and switches configurations to forward pass-through mode.

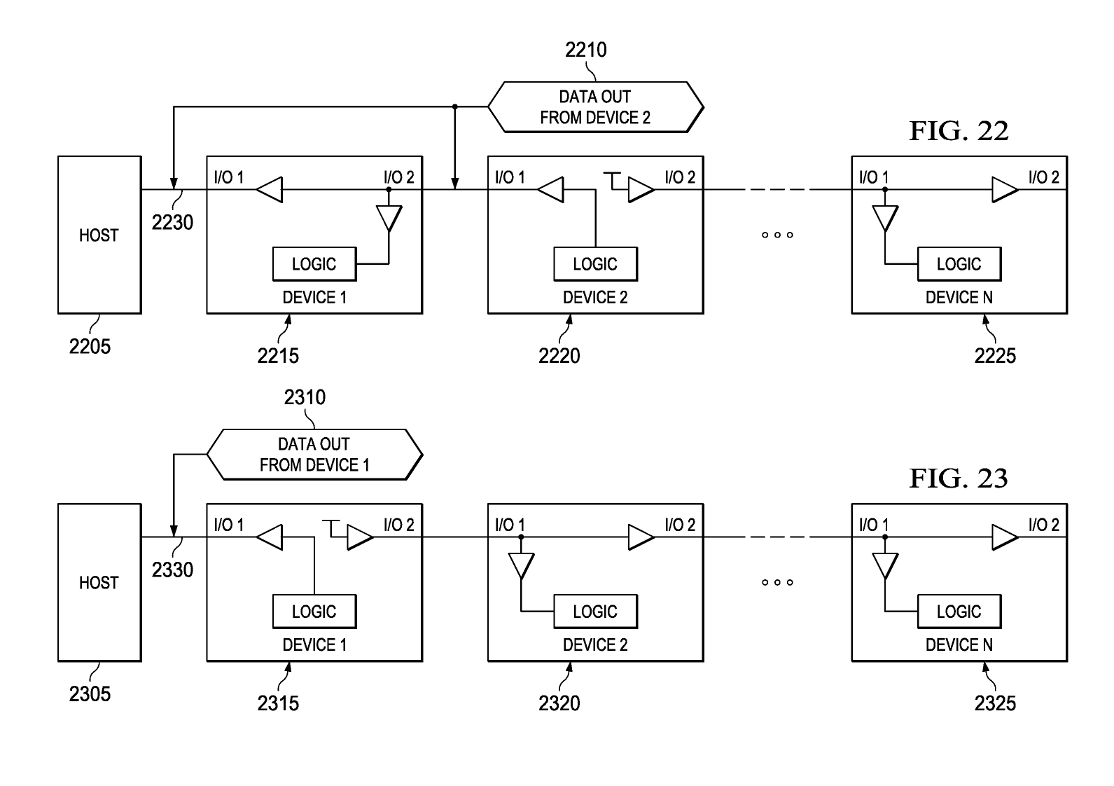

The host controller may also issue global read commands. As described above, in certain embodiments global commands may be limited to a subset of slave devices with addresses above or below a device address specified in the command byte. In the embodiment illustrated in FIGS. 22 and 23, the slave devices are configured to respond to global commands if the device address of the slave device is less than or equal to an address specified by a global command. Referring to FIG. 22, the host controller 2205 issues a global read command directing all slave devices with addresses less than or equal to the device address of the second slave device 2220 to respond to the command. As described above with respect to a global write command, the global read command is received by the first slave device 2215, which reads the command and forwards it to the second slave device 2220. The first slave device 2215 processes the command and determines that its device address is less than or equal to the address specified by the command byte. The first slave device 2215 also calculates the number of downstream devices will also falls within the range of addresses specified by the global read command. The first slave device 2215 pauses further processing of the global read command and switches to reverse pass-through mode. The second slave device 2220 receives the global read command, processes it and determines that its device address is equal to the address specified in the command byte, such that there are no downstream devices in the range specified by the global read command. The third slave device 2225 receives the command and takes no action upon determining that its device address is not included in the specified range of addresses.

Upon determining that its device address matches the device address specified in the global read command such that no downstream devices will respond to the command, the second slave device 2220 retrieves the data stored at the location specified by the register pointer byte of the global read command. The first slave device 2215 transmits the retrieved data by dispatching a data response 2210 upstream to the host controller 2205 via the first slave device 2215. Upon completing this transmission, the second slave device 2220 configures itself to forward pass-through mode. The first slave device 2215, still in reverse pass-through mode, receives the data response 2210, reads the response and forwards it upstream to the host controller 2205.

As illustrated in FIG. 23, the first slave device 2215 processes the data response issued by the second slave device 2220. Based on this processing, the first slave device 2215 determines that no additional data responses are pending from downstream devices. As such, the first slave device 2215 completes its own data response 2310 to the global read command. The first slave device 2215 retrieves the data stored at the register location specified by the register pointer byte and forwards the retrieved data to the host controller via the data response 2310. Upon completing this transmission, the first slave device 2215 switches to forward pass-through mode. The system is now ready to accept another command from the host controller.

As described above, the byte structure of FIG. 17 can be used to issue commands beyond read and write commands. As described with respect to FIG. 19, the command byte includes a bit sequence 1920 that specifies whether a device address or command instruction will be provided in the following bit sequence 1925. In the read and write commands described above, bit sequence 1920 specifies that an address will be provided in the following bit sequence 1925. For commands other than read and writes, bit sequence 1920 specifies that a command instruction will be provided in the following bit sequence 1925 in the command byte, in which case bit sequence 1925 encodes an instruction directing the recipient slave device to perform a specific action. In scenarios where a command instruction is provided by the command byte, the host controller communication ends with the command byte encoding the command instruction. Upon receiving a communication including a command instruction, each of the slave devices, configured in forward pass-through mode, forwards the command and proceeds to processes the command. Based on this process, the slave device determines that a command instruction is included in the command byte and executes a process corresponding to the command instruction.

In addition to the above described advantages provided according to embodiments, numerous other advantages are provided. For instance, by utilizing embodiments efficient address programming can be provided. In conventional address programming procedures, significant delays may result due to uncertainty regarding the completion of the addressing procedure such that device operations may commence. Embodiments provide a technique by which each addressed slave device confirms its address assignment to the host controller. Consequently, the host controller need only be provided with the number of slave devices that have been connected in the daisy chain to determine that the address assignment procedure has failed and may be able to pinpoint the malfunctioning slave device(s). When successful, the address assignment procedure can be exited and device operations may begin as soon as the host controller receives address assignment confirmations matching in number to the number of connected slave devices.

Once initialized, the embodiments utilizing the described communication protocol may provide efficient messaging to a large number of slave devices. In conventional daisy chain communication protocols, communicating with every slave device may require polling each device individually. This is a communication intensive process that is very tedious to manage. Embodiments provide the ability for a host controller to issue commands to one slave device, all slave devices, or certain subsets of the slave devices using a single command.

Embodiments also provide improved efficiency with respect to power consumption. Programming the internal memory of a slave device consumes a significant amount of power. In conventional address programming schemes that program the addresses of all the devices in a daisy chain at the same time, the total instantaneous power consumed can be large. The power to simultaneously program all slave devices is further increased due to significant resistance in the long power supply lines of certain daisy-chained systems. Such power demands can often not be accommodated in systems where many devices are powered using a common regulator with limited current sourcing ability. Even when such surges in power can be accommodated the resulting instantaneous drop in the supply can cause various system malfunctions or spurious behaviors. Embodiments may use much less power for address programming due to the programming progressing sequentially along the daisy chain one device at a time. With only a single slave device being programmed at any one time, in some examples, power requirements remain minimal. Consequently, available power can be utilized more efficiently to address chains of devices connected in longer cable systems.

Additional advantages are provided by embodiments with respect to various implementation efficiencies relative to conventional daisy chain protocols. Embodiments provide the ability to implement an address programming scheme and communication protocol for a daisy chain of slave devices using only a single-wire communication bus connecting the devices. By using a single wire, embodiments minimize the cost, board space and pins required to implement the communication protocol. Conventional daisy chain communication protocols that are unidirectional may require a return wire from the terminal device to the host controller. Such return lines can add significant complexity since this may be a long path from the terminal slave device to the host controller.

Additional advantages are provided by embodiments with respect to configuring, testing and debugging daisy chain systems. In systems where devices are connected in a daisy chain, there is an inherent risk that a single point of failure in one of the devices can disable the entire system. In conventional systems, diagnosing such failures may require manually testing and/or replacing individual devices until the faulty device is located. Embodiments may allow the host controller to easily identify the location of failed slave devices in the daisy chain by issuing diagnostic commands and monitoring the slave devices that reply with responses to the diagnostic command. The ability of the host controller to identify faulty devices is aided by the structure of the daisy chain being known the host controller based on the responses provided by the slave devices to the host controller during address programming. In certain embodiments, the address programming scheme described above may be re-initialized in order to detect faulty slave devices.

Another advantage provided by embodiments is the ability to implement the communication and address assignment protocol using UART communication capabilities that are commonly supported by host controllers and slave devices. Conventional protocols that are able to utilize a single-wire communication bus may require the use of customized communication protocols. Adapting a host controller or slave device to support a customized communication protocol is problematic and costly exercise. Additionally, these customized protocols are often difficult to modify. Certain conventional systems circumvent this issue by using intermediate converter devices in order to broker the use of the customized communication protocol by the host controller. Embodiments, on the other hand, may be implemented using standard UART communication capabilities commonly supported by host controllers and slave devices.

Many modifications and other embodiments will come to mind to one skilled in the art to which this disclosure pertains having the benefit of the teachings presented in the foregoing descriptions, and the associated drawings. Therefore, it is to be understood that the disclosure is not to be limited to the specific embodiments disclosed. Although specific terms are employed herein, they are used in a generic and descriptive sense only and not for purposes of limitation.

What is claimed is:

1. A slave device comprising:
an upstream port connecting the slave device to an upstream device, wherein the upstream port receives an address assignment command from the upstream device, and wherein the address assignment command includes a first device address;
an internal memory configured to store an assigned device address identifying the slave device;
a logic unit operable to program the internal memory to store the first device address as the assigned device address and further operable to increment the first device address to generate a second device address and further operable to generate an updated address assignment command that includes the second device address; and
a downstream port connecting the slave device to a downstream device, wherein the downstream port transmits the updated address assignment command to the downstream device.

2. The slave device of claim 1, wherein the logic unit is further operable to generate an address assignment response command and further operable to transmit the address assignment response command to the upstream device via the upstream port.

3. The slave device of claim 2, wherein the downstream port receives a second address assignment response from the downstream device and wherein the upstream port transmits the second assignment response to the upstream device.

4. The slave device of claim 1, wherein the upstream port is connected to the upstream device via a single wire and wherein the downstream port is connected to the downstream device via a single wire.

5. The slave device of claim 1, wherein the logic unit is further operable to determine if no downstream device is connected to the downstream port.

6. The slave device of claim 2, wherein the upstream port receives an address initialization command from the upstream device, and wherein the downstream port transmits the address initialization command to the downstream device.

7. The slave device of claim 6, wherein the logic unit is further operable to disconnect the downstream port upon transmitting the address initialization command to the downstream device and is further operable to reconnect the downstream port upon transmitting the address assignment response to the upstream device.

8. A host controller device comprising:
a downstream port connecting the host controller to one or more downstream devices connected in a daisy chain via a single-wire communication bus, wherein the downstream port transmits an address assignment command, and wherein the downstream port receives address assignment responses from the one or more downstream devices,
an internal memory configured to store address assignments; and
a logic unit operable to process the address assignment responses to determine a device address assignment for each of the one or more downstream devices and further operable to store the address assignments to the internal memory.

9. The host controller device of claim 8, wherein the address assignment command includes an initial device address.

10. The host controller device of claim 9, wherein the address assignments for each of the one or more downstream devices are sequentially incremented addresses starting from the initial device address.

11. The host controller device of claim 8, wherein the downstream port transmits a memory operation command, the memory operation command addressed to a first downstream device based on the stored address assignment for the first downstream device.

12. The host controller device of claim 11, wherein the memory operation command specifies a memory location of the first downstream device.

13. A slave device comprising:
an upstream port connecting the slave device to an upstream device, wherein the upstream port is configured to receive a command from the upstream device, and wherein the command specifies one or more intended recipients;
a downstream port connecting the slave device to a downstream device, wherein the downstream port is configured to transmit the command to the downstream device;
an internal memory storing an assigned device address identifying the slave device; and
a logic unit operable to determine whether the slave device is an intended recipient of the command based on the assigned device address.

14. The slave device of claim 13, wherein the logic unit is further operable, if the slave device is not an intended recipient, to reconfigure the downstream port to receive a command response from the downstream device and to reconfigure the upstream port to transmit the command response to the upstream device.

15. The slave device of claim 13, wherein the logic unit is further operable, if the slave device is the only intended recipient, to generate a command response and to disable the downstream port and to reconfigure the upstream port to transmit a command response to the upstream device.

16. The slave device of claim 13, wherein the logic unit is further operable to determine whether the downstream device is an intended recipient of the command based on the assigned device address.

17. The slave device of claim 16, wherein the logic unit is further operable, if the slave device is an intended recipient and the downstream device is an intended recipient, to reconfigure the downstream port to receive a first command response from the downstream device and to reconfigure the upstream port to transmit the first command response to the upstream device.

18. The slave device of claim 17, wherein the logic unit is further operable, upon receiving the first command response from the downstream device and transmitting the first command response to the upstream device, to generate a second command response, and to reconfigure the upstream port to transmit the second command response to the upstream device and to disable the downstream port.

19. The slave device of claim 13, wherein the command includes calibration information specifying the baud rate used by the upstream device to transmit the command.

20. The slave device of claim 13, wherein the command specifies a device address identifying a single intended recipient.

21. A method for assigning unique device addresses to a series of devices, the method comprising:
receiving an address assignment command from an upstream device, wherein the address assignment command includes a first device address;
assigning the first device address to a device from the series of devices;
incrementing the first device address to generate a second device address;
generating an updated address assignment command, wherein the updated address assignment command includes the second device address; and
transmitting the updated address assignment command to a downstream device.

22. The method of claim 21, further comprising:
generating a first address assignment response command; and
transmitting the first address assignment response command to the upstream device.

23. The method of claim 22, further comprising:
receiving a second address assignment response from the downstream device; and
transmitting the second assignment response to the upstream device.

24. A method for communicating within a series of devices, wherein each device is assigned a unique identifier and wherein each device comprises a downstream port and an upstream port, the method comprising:
configuring the upstream port of a device from the series of devices, wherein the upstream port is configured to receive communications from an upstream device;
configuring the downstream port of the device to transmit communications to a downstream device;
receiving a command from the upstream device, wherein the command specifies one or more intended recipients;
transmitting the command to a downstream device; and
determining whether the device is an intended recipient of the command.

25. The method of claim 24, further comprising:
if the device is not an intended recipient of the command:
reconfiguring the downstream port to receive a command response from the downstream device; and
reconfiguring the upstream port to transmit the command response to the upstream device.

26. The method of claim 24, further comprising:
if the device is the only intended recipient of the command:
disabling the downstream port;
generating a command response;
reconfiguring the upstream port to transmit communications to the upstream device; and
transmitting the command response to the upstream device.

27. The method of claim 24, further comprising:
determining whether the downstream device is an intended recipient of the command based on the unique identifier of the device.
